(19) United States
(12) Patent Application Publication
(10) Pub. No.: US 2006/0009255 A1
(43) Pub. Date: Jan. 12, 2006

(54) Mobile terminal concept with a slide and twist mechanism

(75) Inventor: Hanna Vuolteenaho, Oulu (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/879,954

(22) Filed: Jun. 29, 2004

(51) Int. Cl. H04M 1/00

(52) U.S. Cl. 455/556.1

(57) ABSTRACT

In accordance with the invention, a mobile communications device is provided. The mobile communication device includes an upper part housing a display, a middle part having a first set of user keys and a lower part having a second set of user keys and a top surface. In a preferred embodiment, the mobile communication device is a mobile telephone. The mobile communications device further includes a rotating means, preferably a hinge, rotatably connecting the upper part and the middle part. In addition, the mobile communications device comprises a sliding assembly slidably connecting said upper part and said middle part to the lower part. The upper and middle parts are slid along the top surface of the lower part in a path defined by the sliding assembly to open or close the mobile device. Further, the upper part housing the display is rotatable about the rotating means when the mobile communication device is in a fully open and operational position. Moreover, the sliding and rotating movements allow the display to be substantially protected from the environment.

### BACKGROUND OF THE INVENTION

1. Field of the Invention

The invention relates to a mobile communications device, and more particularly to mobile communication devices having mechanical transformations that compliment each other making it possible to protect the display of the communication device and adjust the camera angle in relation to the display.

2. Prior Art

The use of pocket size mobile communication devices such as mobile phones has increased substantially in recent years. However, one recurring problem that continues to exist is damage to the displays of mobile communication devices, particularly mobile phone displays tend to break or damage easily, due to the fragile nature of these displays. Typically, the displays of these mobile phones are weak. If these displays are not sufficiently protected, then several different problems may occur.

For example, one such problem with a display of a mobile device lacking any protection, is that this type of device would break easily. Another problem would be that the visibility of the mobile device display, even with a protective window, could erode due to the accumulation of scratches on the surface of the display window. In addition, mobile devices only utilizing protective devices for their displays are perceived as low value/low technology devices. Further, a mobile phone display without sufficient protection is perceived to break easily which causes discomfort amongst consumers. Moreover, in touch sensitive displays the above mentioned protection for the display becomes even more critical because with touch sensitive displays it is not possible to use protective windows for these displays.

Generally, in the prior art, the normal way to protect the display of, for example, a mobile phone is to rely solely on a protective window for the display. However, as noted above, reliance solely on a protective window for the display has several drawbacks and disadvantages.

Certain prior art devices have attempted to rectify the drawbacks of protective window displays. For example, some prior art devices have incorporated folding form factor displays, wherein the display folds down against another piece to protect the display. This method has disadvantages in that these mobile phones are usually bulkier than their non-folding counter-part mobile phones. Also, the folding design limits the possible camera applications one can perform because these type of mobile phones generally do not have rotatable displays. Some mobile phones employ leather or plastic covers in addition to the protective window, but these added measures typically do not provide acceptable display protection.

Slide concepts have also been applied to protect a certain part, e.g. camera lens of mobile phones. For example, U.S. Pat. No. 6,308,084 B1 to Lonka relates in relevant part to a mobile communications device with a camera, employing a slide concept to protect a camera lens when the camera is not in use. However, slide concepts alone do not protect the display of a mobile phone.

Therefore, there is a need in the art for a mobile phone which is designed to provide adequate protection for its display from the environment. There is also a need in the art for a mobile phone wherein its structure not only provides adequate protection for its display from the environment, but also enables different camera mode applications as well. The present invention fulfills these needs, and further provides related advantages.

### SUMMARY OF THE INVENTION

The present invention provides a mobile communications device such as a mobile phone which has two mechanical transformations that compliment and enhance each other. The transformations are known as slide and twist and form what is known as the slide and twist mechanism of the present invention. This invention brings display protection to sliding form factor mobile communication devices. The slide and twist mechanism of the present invention comprises a sliding assembly and a rotating means.

The protection of the display is accomplished by first sliding the mobile phone into a fully open and operational position via the sliding assembly. The display is then rotated via the rotating means, e.g. a hinge to an inward position directly opposite the front portion of the mobile phone, so that when the mobile phone is closed, via the sliding assembly, the display rests against a top surface within the mobile device and is shielded from the environment.

The slide and twist mechanism also makes it possible to adjust the display in relation to the camera, in camera phone embodiments, in order to enable different camera mode applications.

In accordance with the invention, a mobile communications device is provided. The mobile communication device includes a first part having a display and a second part connected to the first part by a movable connection system. The movable connection system is adapted to allow the first part to linearly slide relative to the second part. Further, the movable connection system is also adapted to allow the first part to rotate relative to the second part. In a preferred embodiment, the mobile communication device is a mobile telephone.

In accordance with another aspect of the invention, a mobile phone is provided. The mobile phone includes an upper part that houses a display, a middle part having a first set of user keys located on a top surface of the middle part said upper part and a lower part having a second set of user keys on a top surface of the lower part. The, upper part, middle part and lower part each have a top face and a bottom face. The mobile phone further includes a hinge pivotally connecting the bottom face of the upper part and the top face of middle part together. Further, the mobile phone includes a rail assembly slidably connecting the upper part and the middle part to the lower part. The upper and middle parts are slidable against the top surface of the lower part via the rail assembly towards the top face of the lower part for opening the mobile phone until the sliding of the upper part and middle part reaches a point wherein the top face of the middle part is aligned with the top face of the lower part so that the mobile phone in a fully open and operation position. In addition, the upper and middle parts are slidable against the top surface of the lower part towards the bottom face of the lower part for closing the mobile phone until the sliding of the upper part and middle part reaches a point wherein the bottom face of the middle part is aligned with the bottom face of the lower part so that the mobile phone is in a closed position. The upper part housing the display is rotatable about the hinge when said mobile phone is a fully open and operational position. The mobile phone further includes a digital camera built into the mobile phone, wherein display is rotable via the hinge relative to the camera when the mobile phone is in a fully open and operational position for enabling different camera mode applications. In alternative embodiments, the digital camera is built into a bottom surface of the lower part. In other embodiments, the digital camera is built into a sidewall of the middle part or a sidewall of the lower part. Moreover, when the mobile phone is in the fully open and operational position the display may be rotated so that the display is facing inward away from a front portion of the mobile phone, so that when the mobile phone is closed the display rests against the top surface of the lower part within the mobile device and the display is shielded from the environment.

In accordance with another aspect of the present invention, a method for configuring a mobile communications device is provided. The method includes sliding linearly a first part of the device having a display relative to a second part of the device via a movable connection system; and rotating the first part relative to the second part via the movable connection system.

### BRIEF DESCRIPTION OF THE DRAWINGS

FIG. 1 depicts a perspective view of the mobile communications device of a first embodiment the present invention in a closed but partially operable position;

FIG. 2 depicts a perspective view of the mobile communications device of a first embodiment of the present invention in a fully open and operational position;

FIG. 3 depicts a perspective view of the mobile communications device of a first embodiment of the present invention in a fully closed and substantially non-operable position;

FIG. 4 illustrates the movement of the upper and middle parts of the mobile device of the first embodiment along the top surface of the lower part of the mobile device via the rail assembly;

FIGS. 5(a)-(f) illustrate a cross-section view of a portion of a first section of the rail assembly;

FIGS. 6-8 illustrate the rotation of the upper part of the mobile device housing the display via the hinge;

FIGS. 9(a)-(u) illustrates methods of using the mobile device of the first embodiment of the present invention;

FIGS. 10-11 depict a second embodiment of the present invention comprising a mobile telephone having a built in digital camera; and

FIGS. 12-16 depict different camera mode applications which are enabled using the slide and twist mechanism of the present invention.

### DETAILDED DESCRIPTION OF THE PREFERRED EMBODIMENTS

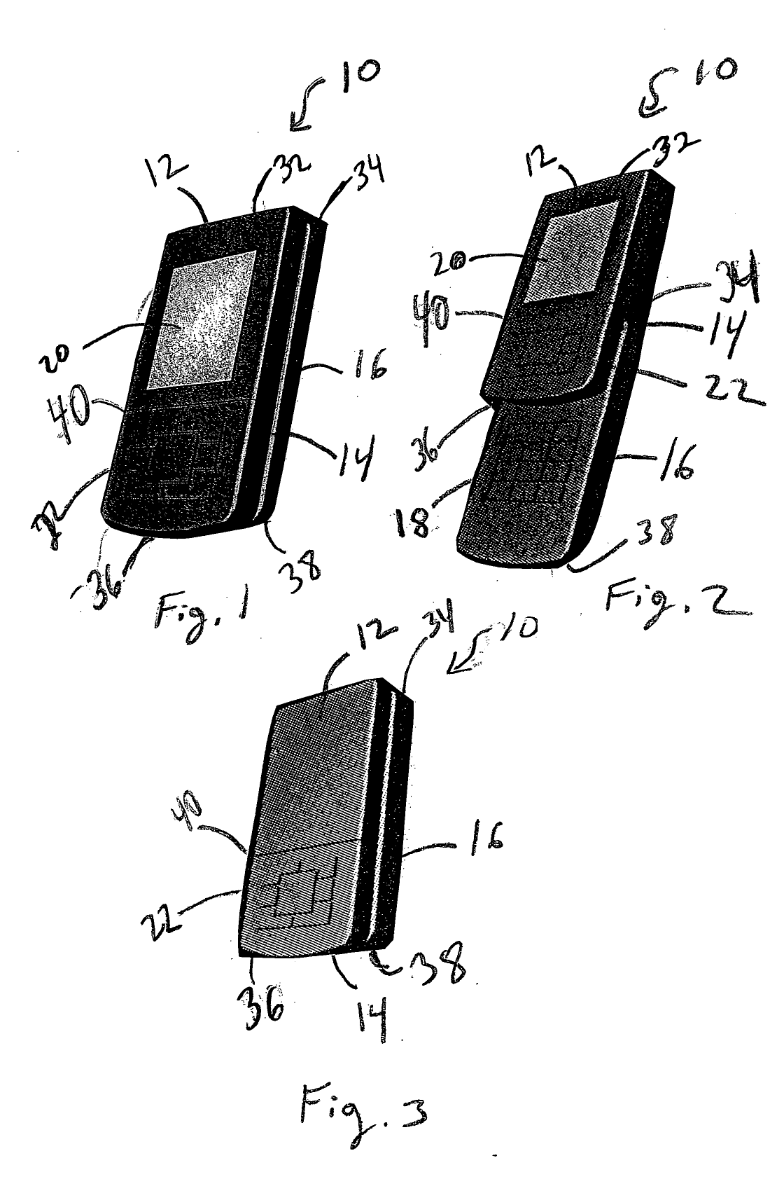

Referring to FIG. 1, there is shown a perspective view of a mobile communication device 10 incorporating features of the present invention. Although the present invention will be described with reference to the exemplary embodiments shown in the drawings, it should be understood that the present invention can be embodied in many alternate forms of embodiments.

In the embodiment shown, the mobile communications device 10 generally comprises a mobile telephone 10. In alternate embodiments, the mobile communications device 10 could comprise any suitable type of mobile communicator, such as a device which comprises a pager function or a text transmission function. The mobile communications device 10 could comprise any suitable type of features including, for example, a digital camera feature.

The mobile phone 10, in the first embodiment shown in FIGS. 1-3, generally comprises an upper part 12, a middle part 14 and a lower part 16. The mobile phone 10 further includes a keypad 18, a display 20, function keys 22, a microphone, a loudspeaker, a transceiver, a battery and other components conventional to a mobile telephone, such as a microprocessor and an antenna.

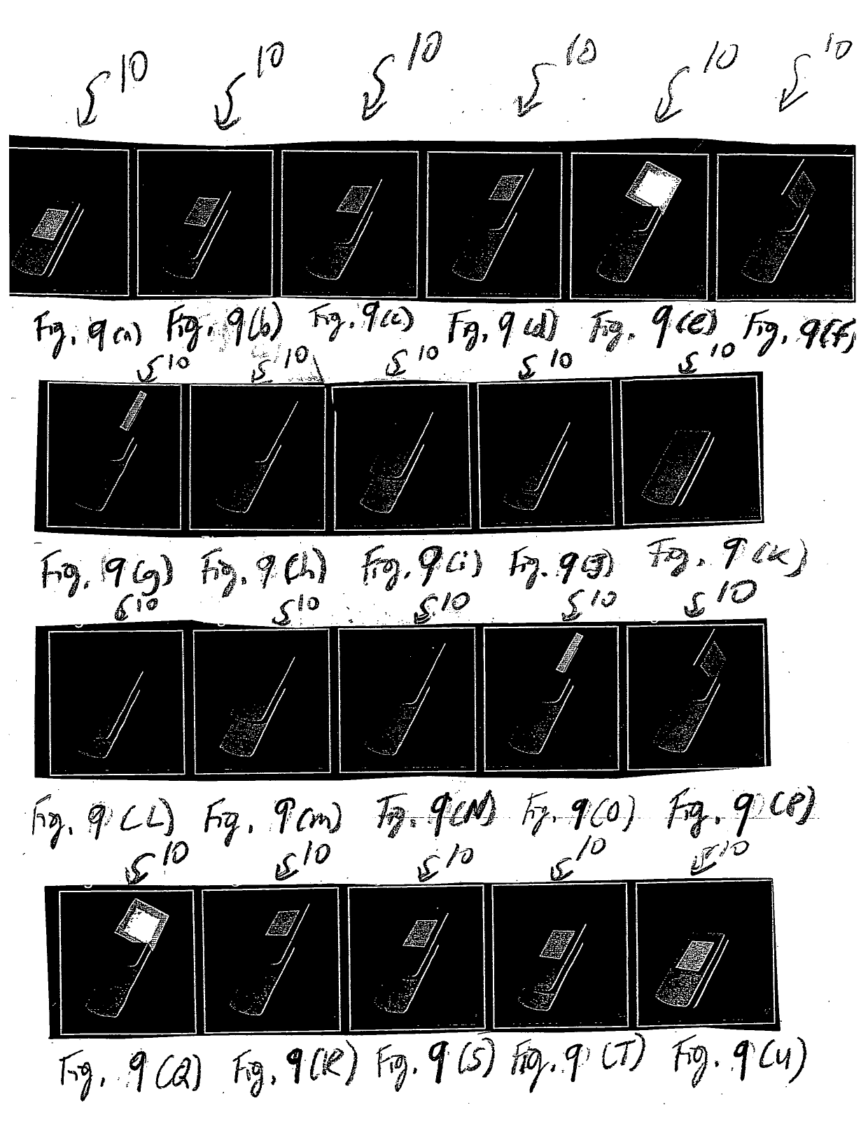

In particular in the first embodiment shown in FIGS. 1-8, the upper part 12 of the mobile 10 phone houses the display 20. The display 20 is preferably a liquid crystal display (LCD) or other other similar electronic display well known to people skilled in the display art for showing text, characters or graphics. The middle part 14 of the mobile phone 10 preferably includes the function keys 22 (e.g. call start and end keys, arrow keys or corresponding browsing keys, memory management keys). Lower part 16 of the mobile phone 10 preferably includes the keypad 18 (e.g. alphanumeric keys for entering telephone numbers or names). In alternate embodiments, the various electronic components e.g. battery, keypad 18, function keys 22 of the mobile telephone 10 could be located in any one of the housing sections 12, 14 or 16.

The mobile phone further comprises a slide and twist mechanism which comprises a sliding assembly 26 or rail assembly and a rotating means or hinge 28. The slide and twist mechanism is used to movably connect the upper part 12, middle part 14 and lower part 16 of the mobile phone together. The slide and twist mechanism also provides some beneficial protective effects to the display 20 of the mobile phone 10 and also enhances and/or enables camera modes described in other embodiments herein.

Specifically, in the first embodiment of the present invention illustrated in FIGS. 1-8, the middle 14 and upper parts 12 are each slidably connected to the lower part 16 via the sliding assembly 26, preferably a rail assembly, which allows for sliding movement of the upper 12 and middle 14 parts along the top surface 30 of the lower part 16 in a linear direction (as shown in FIG. 4) defined by the rail assembly 26. Further, the upper part 12 of the mobile telephone 10 is rotatably connected to the middle part 14 via rotating means 28 (e.g. a hinge) which allows twisting or rotating movement of the display 20 housed within the upper part 12 about a center axis of the hinge 28, as shown in FIGS. 6-8. As already stated herein, it is the connection of the upper 12, middle 14 and lower 16 parts to one another and also the movement of these parts 12, 14 and 16 using the slide and twist mechanism of the present invention, that provides the unique protection of the display 20 and unique enhanced and/or enabled camera modes. The slide and twist mechanism will be discussed in greater detail throughout this application.

In general, the dimensions of the mobile phone 10 of the first embodiment may vary. The materials used in manufacturing the mobile phone 10 may also vary. For example, the mobile phone 10 may be constructed of either metals, plastics, ceramics, or any combinations thereof. In a preferred embodiment, since the mobile phone 10 is a hand held device, none of the principal dimensions (e.g. width, height or thickness) should be over 25 centimeters. However, any suitable dimensions could be provided, such as when the present invention is used in a larger device. Moreover in a preferred embodiment, the combined principal dimensions of the upper 12 and middle part 14 should substantially equal the principal dimensions of the lower part 16, so that when closing the phone 10 (via sliding the upper 12 and middle parts 14 along the top surface 30 of the lower part 16, via the rail assembly 26), the entire lower part 16 is substantially covered by the upper 12 and middle 14 part. The middle 14 and upper parts 12 together, however, may for example also be wider and/or longer than the lower part 16 because the requirement is only that the upper 12 and middle 14 parts together substantially cover the top surface 30 of the lower part 16.

Referring particularly to FIGS. 1-3, these figures show the mobile phone 10 in different positions or configurations. FIG. 1 illustrates the mobile phone 10 in a closed, but partially operational position. More specifically in the position of FIG. 1, the top face 32 of the upper part 12 is aligned with the top face 34 of the lower part 16 and the bottom face 36 of the middle part 14 is aligned with the bottom face 38 of the lower part 16, so that together the upper 12 and middle 14 parts are covering substantially the entire lower part 16. In FIG. 1, it is also noted that the display 20 of the mobile phone 10 is facing outward and accessible/viewable. Although the mobile phone 10 is in the closed position with the keypad 18 covered, it can still be used for certain purposes, e.g. accept incoming calls by means of the function keys 22.

Further, it is not a requirement that the surfaces of the mobile phone 10 as discussed above and depicted in FIG. 1 be aligned. For example, in other embodiments (some of which are discussed below), the surfaces are not aligned, but rather e.g., the upper part 12 and at least a portion of the middle part 14 are higher than the lower part 16.

FIG. 2 shows the mobile phone 10 in a fully open and operational position. In particular, FIG. 2 depicts the mobile phone 10 of FIG. 1 that has been fully opened by sliding the upper 12 and middle 14 parts along the top surface 30 of the lower part 16, via the rail assembly 26, in a direction away from the keypad 18 towards the top face 34 of the lower part 16. The middle 14 and upper 12 parts are slid along the top surface 30 of the lower part 16 until the top face 40 of middle part 14 and the top face 34 of the lower part 16 are aligned with one another, or stated otherwise, slid as far as the upper part 12 and middle part 14 are able to physically slide in the direction toward the top face 34 of the lower part 16, thereby placing the mobile phone 10 into a fully open and operational position.

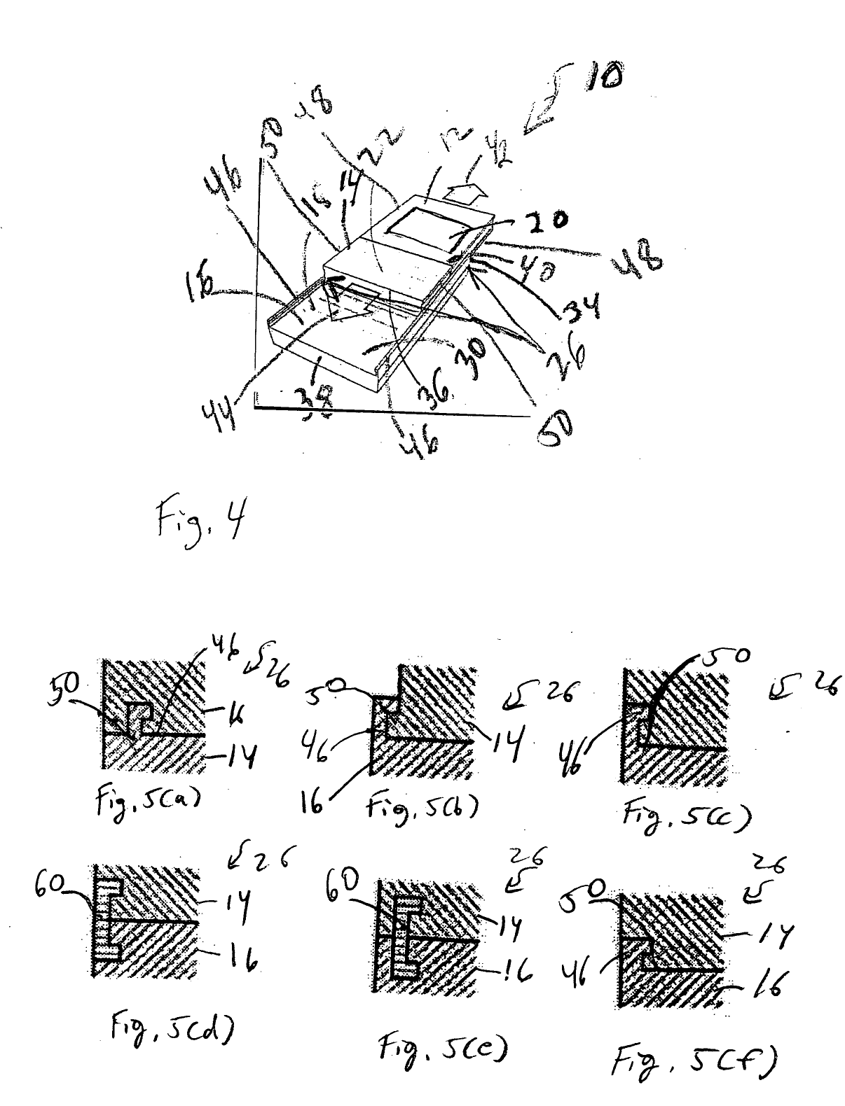

FIG. 3 depicts the mobile phone 10 in its fully closed, substantially non-operational position with the display 20 protectively hidden. Although the mobile phone 10 depicted in FIG. 3 is in the fully closed, substantially non-operation position, it still has some functionality, e.g. accepting an incoming call. In addition, in alternative embodiments a small secondary display is located preferably on the bottom surface of the lower part 16 for providing watch and caller ID functionality.

More particularly, FIG. 3 depicts the mobile phone 10 of FIG. 2 which has been maneuvered into the fully closed, non-operational position by way of the slide and twist mechanism. Namely in order to accomplish the above, the upper part 12 which houses the display 20 of the mobile phone 10 depicted in FIG. 2 is first rotated about 180 degrees via the hinge 28 so that the display 20 is now facing in the opposite direction then the display 20 depicted in FIG. 2. For obvious reasons that are readily apparent from the description and the drawings, the display 20 of the mobile phone 10 of the first embodiment can only be rotated when the mobile phone 10 is in the fully open and operational position as depicted in FIG. 2.

Next, also with regard to FIG. 3, the upper 12 and middle part 14 are slid along the top surface 30 of the lower part 16 in a direction towards the keypad 18, until the bottom face 36 of the middle part 14 and the bottom face 38 of the lower part 16 are aligned with one another. Once the above alignment occurs, the mobile phone 10 is now in the fully closed, non-operational position with the keypad 18 protected from the environment and the display 20 turned inward towards the top surface 30 of the lower part 16, and thus, inaccessible to the user and the environment. Most notably, the display 20 is now fully protected from environmental effects such as dust and scratching objects by having been rotated and slid using the slide and twist mechanism of the present invention. A more detailed discussion regarding the slide and twist mechanism is set forth below.

As already stated, the slide and twist mechanism consists of the sliding assembly 26 and the rotating means 28. A more detailed description of these elements is discussed 10 below.

First, the sliding mechanism or rail assembly 26, as mentioned above, allows for sliding movement of the upper 12 and middle 14 parts together along the top surface 30 of the lower part 16 of the mobile phone 10. The sliding of the upper 12 and middle parts 14 is linear either in the direction towards (shown by arrow 42 in FIG. 4) the top face 34 of the lower part 16 (e.g. in order to open the mobile phone 10) or in the direction towards (shown by arrow 44 in FIG. 4) the bottom face 38 of the lower part 16 (e.g. in order to close the mobile phone 10) The sliding movement can be either straight or it follows an arch, depending upon the construction of the sliding assembly or rail assembly 26.

It is noted that there are different degrees of opening and closing the mobile phone 10. In other words, one could partially open the mobile phone 10 from a closed position, by sliding and then locking into position the upper 12 and middle parts 14 via the rail assembly 26 at any point going towards the top face of the lower part up until right before the point where the bottom face 36 of the middle part 14 becomes aligned with the top face 34 of the lower part 16. If one desired the mobile phone to be in a fully open and operational position one would continue to slide the upper 12 and middle 14 parts along the top surface 30 of the lower part 16 via the rail assembly 26 until the top face 40 of the middle part 14 became aligned with the top face 34 of the lower part 16. In alternate embodiments, the fully open and operational position occurs at a higher position than the previously discussed embodiment, such that the top face 40 of the middle part 14 is extended in a position above the top face 34 of the lower part 16 (in a direction moving further away from the bottom face 38 of the lower part 16).

Alternatively, if one wished to partially close the mobile phone 10 which was at least partially open, one could slide the upper 12 and middle 14 parts via the rail assembly 26 along the top surface 30 of the lower part 16 in a direction towards the bottom face 38 of the lower part 16 up until right before the point where the bottom face 36 of the middle part 14 becomes aligned with the bottom face 38 of the lower part 16. If one desired the mobile phone 10 to be in a fully closed, one would continue to slide the upper 12 and middle 14 parts along the top surface 30 of the lower part 16 via the rail assembly 26 until the bottom face 36 of the middle part 14 became aligned with the bottom face 38 of the lower part 16.

In alternate embodiments, one could slide the upper 12 and middle 14 parts via the rail assembly 26, in a direction away from the top face 34 of the lower part 16, to a point such that the bottom face 36 of the middle part 14 extends at least partially below the bottom face 38 of the lower part 16. In yet other embodiments, one could slide the upper 12 and middle 14 parts via the rail assembly 26, in a direction away from the top face 34 of the lower part 16, such that substantially the entire middle part 14 extends below the bottom face 38 of the lower part 16, so as to reveal for example, storage media, a battery, charging component or other component located in the bottom surface of the middle part 14.

The sliding assembly or rail assembly 26 can be constructed in many different ways. The main principle is that the upper 12 and middle 14 parts slide against the top surface 30 of the lower part 16 following a continuous path, defined by the slide assembly or rail assembly 26.

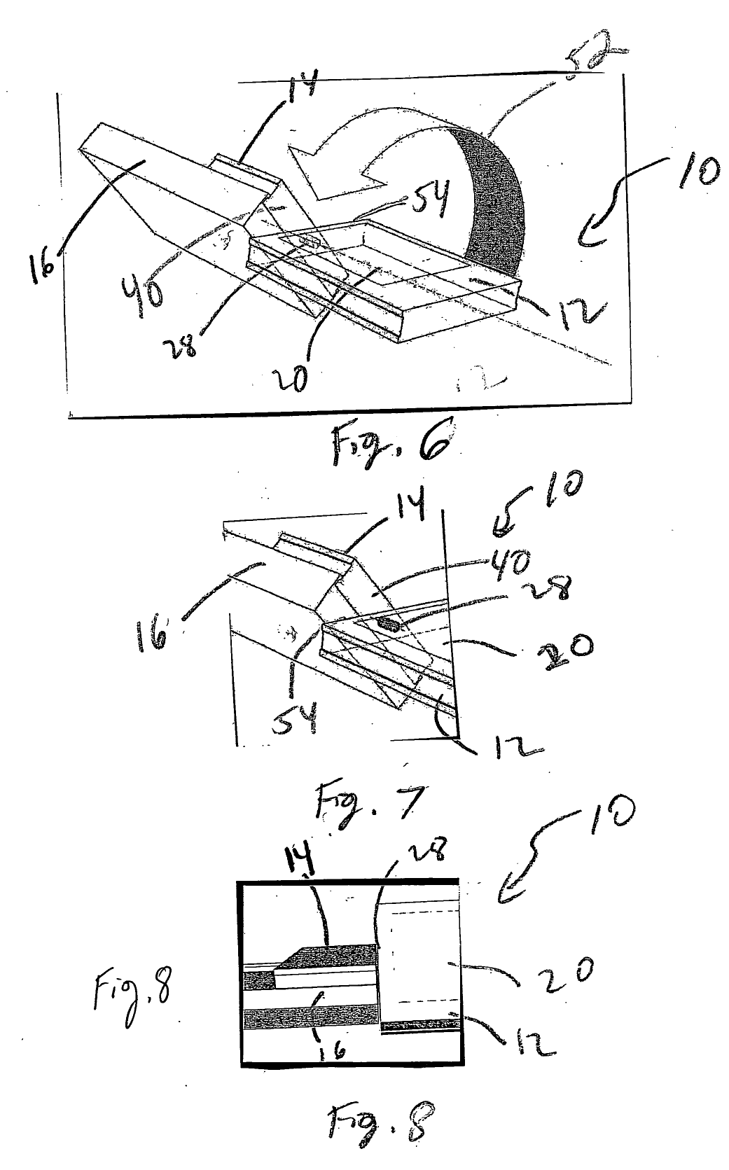

In embodiments illustrated in FIGS. 5(a)-(c) and (f), the sliding assembly is a rail assembly 26 comprised of a first section and a second section. The first section of the rail assembly is located on the left side of the mobile phone 10 and the second section of the rail assembly 26 is located on the right side of the mobile phone 10. Further, the first and the second section of the rail assembly 26 each comprise a gripping feature 46 and a slot feature 50. Moreover, together, the first and second sections of the rail assembly 26 slidably connect the upper 12 and middle 14 parts to the lower part 16. The gripping feature 46 of the rail assembly 26 describes an element that is protruding (as shown in FIGS. 5(a)-(c)) from either of the facing parts (lower 16, middle 14 or upper parts 12). The slot feature 50 of the rail assembly 26 describe an element located on the other part corresponding (lower 16, middle 14 or upper parts 12) to the facing part that allows the gripping feature 46 to grip onto a slot that the slot feature 50 provides. The facing part is defined herein as the part facing the other part. In other words, for example, if the gripping feature 46 is protruding from the middle part 14 then the facing part in this situation is the lower part 16. Together, the gripping feature 46 and slot feature 50 create the rail mechanism 26 for linear movement.

By way of example, the embodiments depicted in FIGS. 5 (a)-(c) and (f), depict a cross-sectional view of a portion of the first section of the two section rail assembly 26, located on the left side of the mobile phone 10. In particular, the embodiment depicted in FIG. 5(a), the gripping feature 46 is protruding from the lower part 16 and the slot feature 50 is located on the bottom surface of the middle part 14 of the mobile phone 10. In the embodiment depicted in FIG. 5(b), the gripping feature 46 is protruding from the lower part 16 and the slot feature 50 is located on the left side of the middle part 14. In the embodiment depicted in FIG. 5(c), the gripping feature 46 protrudes from the lower part 16 and the slot feature 50 is located on the left side of the middle part 14. In another embodiment depicted in FIG. 5(f), the gripping feature 46 protrudes from the lower part 16 and the slot feature 50 is located on a bottom left hand side corner of the middle part 14. However, as mentioned above there are several different possible combinations for the placement of the gripping feature 46 and slot feature 50. For example, instead, the gripping feature 46 may protrude from the upper 12 and/or middle parts 14 and the slot feature 50 may be located on the lower part 16.

In alternative embodiments, the first section of the rail assembly 26 comprises a rail feature 60 and the second section of the rail assembly comprises a rail feature 60. In particular, FIG. 5(d) depicts a cross-sectional view of a portion of the first section of the rail assembly 26 located on the left side of the mobile phone 10, wherein the rail feature 60 connects the middle 14 and lower parts 16 together from the side. FIG. 5(e) depicts a cross-sectional view of a portion of a first section of the rail assembly 26 located on the left side of the mobile phone 10, wherein the rail feature 60 connects the middle part 14 and lower parts 16 together from in between the middle 14 and lower parts 16.

It is again noted that while the above embodiments depicted in FIGS. 5(a)-(f) make reference only to the first section of the rail assembly 26 located on the left side of the mobile phone 10, the same principles also apply to the second section of the rail assembly located on the right side of the mobile phone 10 as well. Further, the above embodiment for the rail assembly 26 is but preferred embodiments and, thus, any slide assembly or rail assembly 26 known in the art which is in accordance with the principles of the present invention may likewise be used.

The other constituent of the slide and twist mechanism, the rotating means or hinge 28, is now discussed in further detail. In the first embodiment as depicted in FIGS. 1-8, the rotating means is preferably a hinge 28. The hinge 28 is specifically illustrated in FIGS. 6-9, and as mentioned above, rotatably connects the upper 12 and middle parts 14 together, allowing for twisting movement (illustrated by arrow 52 in FIG. 6) of the upper part 12 which houses the display 20. In particular, as shown in FIGS. 6-8, the hinge 28 acts as a pivotal axis that is located between the top face 40 of the middle part 14 and the bottom face 54 of the upper part 12. The hinge 28 keeps the bottom face 54 of the upper part 12 facing the top face 40 of the middle part 14, allowing rotation of the upper part 12 housing the display 20 around the center axis of the hinge 28. In one embodiment, the hinge 28 may be rotated about its center axis at an angle anywhere from about 0 to about 180 degrees in one direction. In a preferred embodiment, the hinge 28 may be rotated about its center axis at an angle anywhere from about 0 to about 360 degrees, or more, causing a corresponding rotation of the display 20. The ability to rotate the display 20 provides the user with the ability to protect or shield the display 20 from the environment, and in mobile phones equipped with a built in camera, the rotating movements achieved with the hinge 28 provides additional benefits such as enabling and/or enhancing different camera modes applications.

The hinge 28 may be constructed in many ways. For example it may be a pin, tube, bar or equivalent. It may also be a combination of a pin, tube, bar or equivalent. The hinge may be constructed of several parts. Moreover, the hinge 28 may be built into either the top face 40 of the middle part 14 or alternatively into the bottom face 54 of the upper part 12.

Now referring to FIGS. 9(a)-(u), methods of using the mobile phone 10 of the first embodiment are specifically illustrated. Most importantly, the workings of the slide and twist mechanism are specifically illustrated in these figures. These methods illustrated in FIGS. 9(a)-(u) are by way of example only and are in no way meant to limit the scope of the present invention. For example, a user starting with the mobile phone 10 depicted in FIG. 9(a), a mobile phone 10 which is in the closed position but partially operation because the display 20 is facing outward and accessible to the user, could use the function keys for example to send or receive a phone call, or use scrolling features. However, if the user desired full access to the mobile phone 10, including access to the alphanumeric keypad 10, the user would slide the upper part 12 and middle part 14 which are connected together, against the top surface 30 of the lower part 16, using the rail assembly 26, in a direction away from the keypad 18 towards the top face 34 of the lower part 16 (as shown in FIG. 9(b)) until the bottom face 36 of the middle part 14 was at least above the keypad 18 (as shown in FIG. 9 (c)). Additionally, if one desired not only to have access to the keypad 18 but also to have the mobile phone 10 in a fully open and operational position as well (for example to be able to rotate or twist the display 20), they could continue to slide the upper 12 and middle part 14 against the top surface 30 of the lower part 16 until the top face 40 of the middle part 14 was aligned with the top face 34 of the lower part 16, or stated otherwise, the upper 12 and middle parts 14 were slid as far as they could go in the direction of the top face 34 of the lower part 16.

After the user was finished operating (e.g. making a telephone call) the mobile phone 10 depicted in either FIG. 9(c) or 9(d), they could now close the phone and also protect the display from the environment. In order to accomplish the above, the user would first place the mobile phone 10 in its fully operational position, if this had not already been done, simply by sliding the upper 12 and middle part 14 against the top surface 30 of the lower part 16 so that the top face 40 of the middle part 14 is aligned with the top face 34 of the lower part 16. The user then rotates the upper part 12 of the mobile phone depicted in FIG. 9(d), e.g. 180 degrees (as shown in FIGS. 9(e)-(h)) so that the display 20 housed in the upper part 12 would now be facing in the opposite direction from its original direction, as shown in FIG. 9 (h).

The next step is to slide the upper 12 and middle parts 14 of the mobile phone 10 depicted in FIG. 9 (h) in a direction towards the bottom face 38 of the lower part 16 and towards the keypad 18 (as shown in FIGS. 9(i)-(j) until the bottom face 36 of the middle part 14 and the bottom face 38 of lower part 16 are aligned with one another, so that the entire lower part 16 is substantially covered by the upper 12 and middle part 14 combination, thereby placing the mobile phone in a fully closed, substantially non-operational position (as shown in FIG. 9(k). Further, as can be seen in FIG. 9(k), the keypad 18 and the display 20 are each shielded or protected from the environment when the mobile phone 10 is in this fully closed position. Most notably, the display 20 is protected from the environment because having been rotated 180 from its original position, it was now facing inward away from contact with the environment, so that when the mobile phone was closed the display 20 lay flat against the top surface 30 of the lower part 16 away from access to the user and the environment. The beneficial protective effects of the slide and twist mechanism of the present invention are specifically described and illustrated in the figures above.

Alternatively, by way of illustration, the user could operate the mobile phone 10 depicted in FIG. 9(k), which as mentioned is in the fully closed position with the display facing inward, and thus, protected from the environment. The operation of the phone depicted in FIG. 9 (k) would be the same as described above for the phone 10 depicted in FIG. 9 (a), except that with the mobile phone of FIG. 9 (k), the display 20 starts out protected from the environment and ends up accessible to the user and the environment when the mobile phone 10 is ultimately closed as shown in FIG. 9 (u). This specific operation of the mobile phone 10 of FIG. 9(k) is illustrated in FIGS. 9(l)-(u).

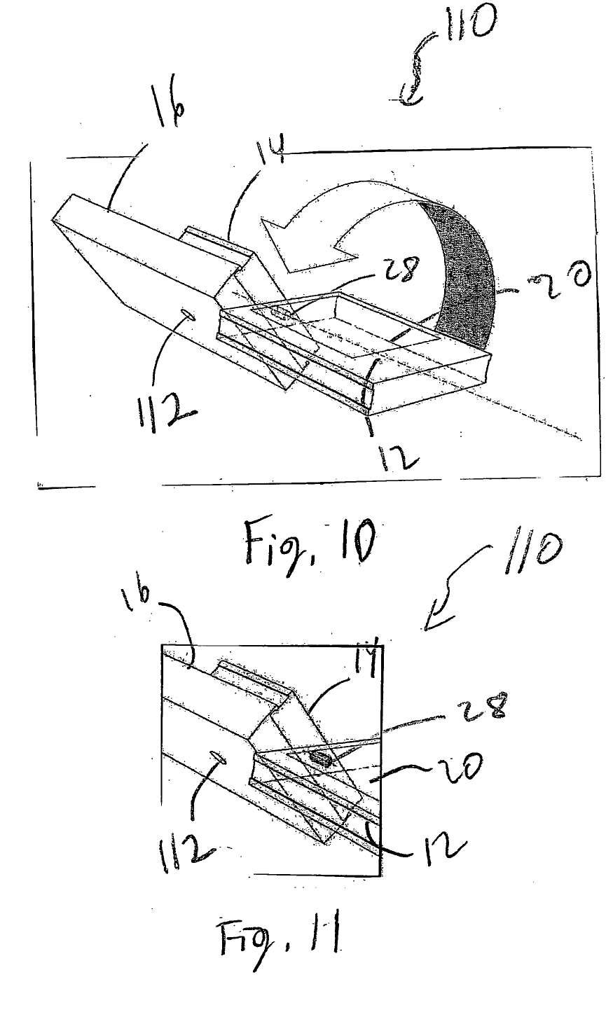

A second embodiment of the present invention is depicted in FIGS. 10-16. This embodiment depicts a mobile phone 110 having a built in camera 112, preferably a digital camera. The mobile phone in this embodiment is identical to the mobile phone 10 of the first embodiment, with the exception of the built in camera 112. Most importantly, since the camera phone 110, includes all of the elements of the mobile phone 10 of the first embodiment, it also includes the slide and twist mechanism described in the first embodiment as well. Therefore, the mobile phone 110 of the second embodiment is opened and closed in the same manner as the mobile phone 110 of the first embodiment, and the display 20 of the mobile phone 110 is also protected from the environment in the same manner as the display 20 of the first embodiment. In addition, the slide and twist mechanism provides some additional benefits for the mobile phone 110 in relation to use of its camera modes.

As shown in FIGS. 10 and 11, the camera 112 is preferably located in the bottom surface of the lower part 16. In alternative embodiments, the camera 112 may be located in different parts of the mobile phone 110, e.g., in a sidewall of the lower part 14 or in a sidewall of the middle part 14 (as shown in FIG. 16), such that camera is pointing sideways. The camera phone 110 includes the capabilities of conventional digital camera phones such as digital photography, storing of digital images, video conferencing, linkage to a networks for content swapping and any other digital phone camera technology known in the art. In addition, the slide and twist mechanism also enables and/or enhances different camera modes or applications of the second embodiment because of the twisting or rotating movement provided by this mechanism. Namely, the angle between the camera 112 and the display 20 can be varied, enabling and/or enhancing different applications of use. This variance of angles between the display 20 and the camera 112 is accomplished by rotating the upper part 112 of the mobile phone 110 anywhere from about 0 to 360 degrees about the central axis of the hinge 28.

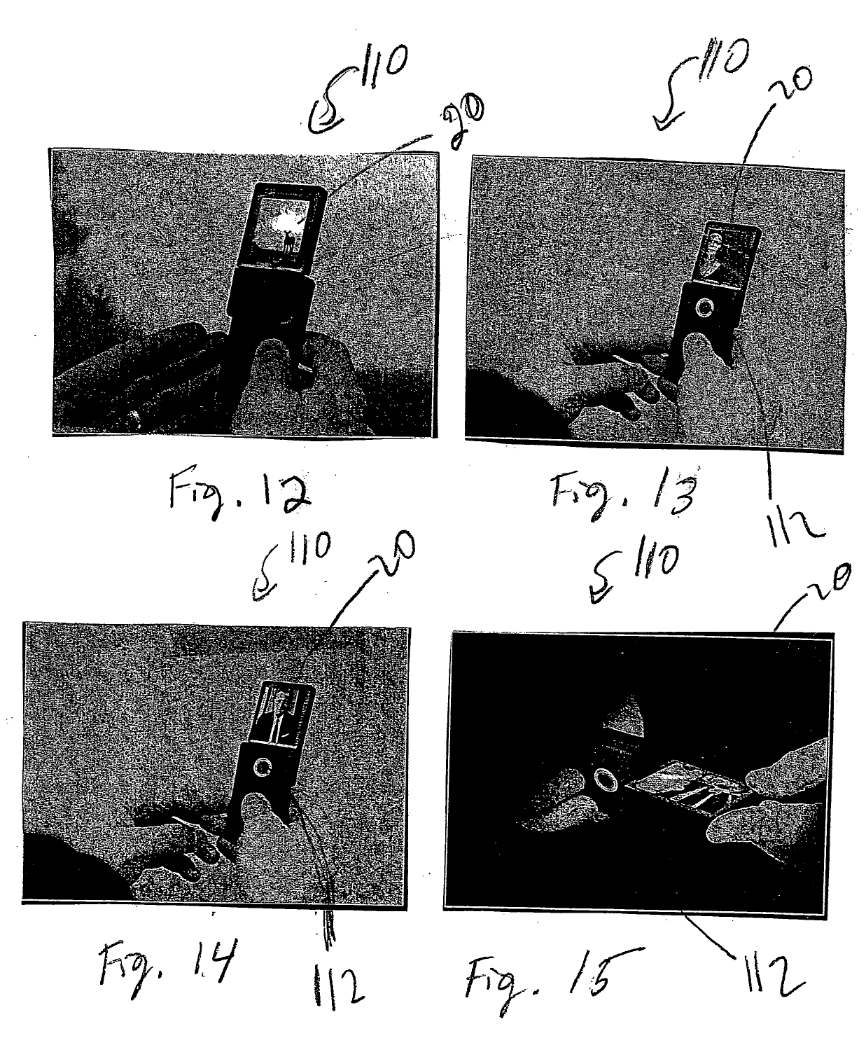

For example, FIG. 12, illustrates imaging and sharing what a particular user sees. Here, the camera 112 of the mobile phone 110 is pointing in the opposite direction than the display 20, so that imaging is occurring through the mobile phone 110. This feature allows you to view on the display 20 what you are aiming at with the camera 112 of the mobile phone 110. You may also share the captured image with a recipient over a network.

FIG. 13 represents two users sharing or swapping content. When content swapping using the slide and twist mechanism of the second embodiment, one user may share what he or she sees on their display 20 with a second user. The second user may in turn share with the first user, using his or her own camera 112 an image captured of himself or herself or an image of what he or she is seeing. Also, for example, both users could see a document that was being captured by one of the users and which is then shared to both users to be seen on both of their displays 20. FIG. 13 illustrates content swapping in the form of a videoconference, wherein both users are capturing their own faces with their own camera 112, while at the same time seeing the other person in their display 20. This videoconference mode illustrated in FIG. 13 is enabled due to the twisting or rotating movements of the display 20 relative to the camera 112 of the mobile phone 110.

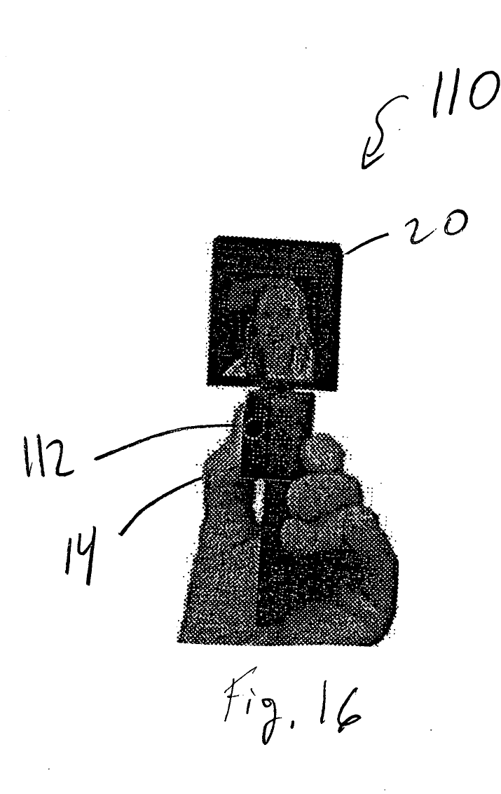

FIG. 14 represents a user imaging themselves and viewing the image of themselves at the same time. This user is able to view his or her own image while simultaneously capturing this image because the twisting movement of the slide and twist mechanism enables one to point the camera 112 towards themselves, while being able to view the display 20 at the same time.

FIG. 15 illustrates discreet imaging. This discreet imaging mode is almost the same as the imaging & sharing what you see mode depicted in FIG. 12, but since you can twist the angle between the camera 112 and the display 20, you don't need to point the camera 112 towards the target through the mobile phone 110. Instead, you can have the camera 112 high or low on your body which gives you much more flexibility in areas where direct pointing would not be desirable. This ability to adjust the angle of the display 20 relative to the camera 112 is especially useful in crowds where you can also view the image you capture with your hands raised, looking up at the display 20.

As can be seen from the FIGS. 12-16, just a simple adjustment of the angle of the display 20 relative to the camera 112 provides the user with many different camera mode possibilities and applications. The rotation of the display 20 also optimizes the viewing angle of the camera mobile phone 110.

Although a particular embodiment of the invention has been described in detail for purposes of illustration, various modifications and enhancements may be made without departing from the spirit and scope of the invention. Accordingly, the invention is not to be limited except as by the appended claims.

1. A mobile communications device comprising:
a first part having a display; and
a second part connected to the first part by a movable connection system, wherein the movable connection system is adapted to allow the first part to linearly slide relative to the second part, and wherein the movable connection system is adapted to allow the first part to rotate relative to the second part.

2. The mobile communications device of claim 1, wherein said device is a mobile telephone.

3. The mobile communications device of claim 1, wherein said movable connection system comprises a hinge and a rail assembly, said hinge rotatably connects the first part and the second part allowing the first part to rotate relative to the second part, said rail assembly slidably connects the first part to the second part allowing the first part to slide relative to the second part.

4. The mobile communications device of claim 3, wherein said first part having the display is rotatable about said hinge at an angle from about 0 to an angle greater than 360 degrees.

5. The mobile communication device of claim 1, wherein said device further comprising a third part which is rotatably connected to the first part via the movable connection system, said first part and third part being slidably connected to the second part via the movable connection system.

6. The mobile communications device of claim 5, wherein said movable connection system comprises a hinge and a rail assembly, said hinge rotatably connects the first part and the third part, said rail assembly slidably connects the first part and the third part to the second part.

7. The mobile communications device of claim 6, wherein said first part and third part each follow a linear path defined by the rail assembly either towards a top face of the second part to open the device or towards a bottom face of the second part to close the device.

8. The mobile communications device of claim 7, wherein the first part having the display may be rotated in a direction opposite to a front portion of the communications device so that when the first and third parts are slid along a top surface of the second part to close the device the display now faces inward toward the top surface of the second part of the mobile device and the display is substantially protected from any environment effects when the device is closed.

9. The mobile communications device of claim 5, wherein said third part has a set of functional keys.

10. The mobile communications device of claim 5, wherein said second part has an alphanumeric keypad.

11. The mobile communications device of claim 6, wherein said rail assembly comprises
a first rail assembly section comprising at least one gripping feature and a least one slot feature, said at least one gripping feature and a least one slot feature are operatively connected to one another along a left side of the mobile communications device; and
a second rail assembly section comprising at least one gripping feature and a least one slot feature, said at least one gripping feature and a least one slot feature are operatively connected to one another along a right side of the mobile communications device.

12. The mobile communications device of claim 1, wherein said display is a liquid crystal display (LCD).

13. The mobile communications device of claim 5, further comprising a digital camera built into a bottom surface of the second part.

14. The mobile communications device of claim 5, further comprising a digital camera built into a sidewall of the second part.

15. The mobile communications device of claim 5, further comprising a digital camera built into a side wall of the third part apart.

16. The mobile communications device of claim 13, wherein said rotation of the display allows for the enabling of certain camera modes comprising at least one of imaging/sharing, content swapping, mirror imaging oneself and discreet imaging.

17. A mobile phone comprising:
an upper part housing a display; said upper part having a top face and a bottom face;
a middle part having a first set of user keys located on a top surface of said middle part; said upper part having a top face and a bottom face
a lower part having a second set of user keys on a top surface of said lower part; said lower part having a top face and a bottom face;
a hinge pivotally connecting the bottom face of the upper part and the top face of middle part together,
a rail assembly slidably connecting said upper part and said middle part to the lower part, said upper and middle parts are slidable against the top surface of the lower part via the rail assembly towards the top face of the lower part for opening the mobile phone until the sliding of said upper part and middle part reaches a point wherein the top face of the middle part is aligned with the top face of the lower part so that the mobile phone in a fully open and operation position, said upper and middle parts are slidable against the top surface of the lower part towards the bottom face of the lower part for closing the mobile phone until the sliding of said upper part and middle part reaches a point wherein the bottom face of the middle part is aligned with the bottom face of the lower part so that the mobile phone is in a closed position, said upper part housing the display is rotatable about the hinge when said mobile phone is a fully open and operational position;
a digital camera built into the mobile phone, said display is rotatable via said hinge relative to said camera when said mobile phone is in a fully open and operational position for enabling different camera mode applications; and
wherein when said mobile phone is in the fully open and operational position the display may be rotated so that the display is facing inward away from a front portion of the mobile phone, so that when the mobile phone is closed the display rests against the top surface of the lower part within the mobile device and the display is shielded from the environment.

18. The mobile phone of claim 17, wherein said digital camera is built into a bottom surface of the lower part.

19. The mobile phone of claim 17, wherein said digital camera is built into a sidewall of the middle part.

20. The mobile phone of claim 17, wherein said digital camera is built into a side wall of the lower part apart.

21. The mobile phone of claim 17, wherein said first set of user keys comprises functional keys.

22. The mobile phone of claim 17, wherein said second set of user keys comprises an alphanumeric keypad.

23. The mobile phone of claim 17, wherein said display is a liquid crystal display (LCD).

24. The mobile phone of claim 17, wherein said rotation of the display allows for the enabling of certain camera modes comprising at least one of imaging/sharing, content swapping, mirror imaging oneself and discreet imaging.

25. The mobile phone of claim 17, wherein said upper part housing the display is rotatable about said hinge at an angle from about 0 to an angle greater than 360 degrees.

26. The mobile phone of claim 17, wherein said rail assembly comprises
a first rail assembly section comprising at least one gripping feature and a least one slot feature, said at least one gripping feature and a least one slot feature are operatively connected to one another along a left side of the mobile phone; and
a second rail assembly section comprising at least one gripping feature and a least one slot feature, said at least one gripping feature and a least one slot feature are operatively connected to one another along a right side of the mobile phone.

27. A method of configuring a mobile communications device comprising:
sliding a first part of the device having a display linearly relative to a second part of the device via a movable connection system; and
rotating the first part relative to the second part via the movable connection system.

28. The method of claim 27, wherein said mobile communication device further comprises a digital camera said built into said mobile communications device, and wherein rotation of the display allows for the enabling of specific camera applications comprising at least one of imaging/sharing, content swapping, mirror imaging oneself and discreet imaging.

29. The method of claim 27, wherein said digital camera is built into a bottom surface of the second part.

30. The mobile phone of claim 27, wherein said digital camera is built into a sidewall of the second part.

31. The mobile phone of claim 27, wherein said digital camera is built into a sidewall of the first part.

32. The method of claim 27, wherein said mobile communications device is a mobile telephone.

33. A portable electronic device comprising:
a first and a second component coupled to one another by coupling means, wherein at least one of the first and second components comprises a graphical display interface; and
further wherein the coupling means comprises means for sliding the first and second components relative to one another and means for rotating at least a portion of one of the first and second components relative to the other component.

34. The portable electronic device of claim 33, wherein
the first component comprises the graphical display interface;
the second component comprises a sliding portion and a rotating portion;
the means for sliding comprises a rail system with mating rails on the first component and the sliding portion; and
the means for rotating comprises a pivotal axle between the sliding portion and the rotating portion.
